(19) United States
(12) Patent Application Publication
(10) Pub. No.: US 2026/0175816 A1
(43) Pub. Date: Jun. 25, 2026

(54) METHODS AND SYSTEMS FOR MANAGING VEHICLE ACCESS

(71) Applicant: J.B. Poindexter & Company, Houston, TX (US)

(72) Inventors: Parshwa Patwa, Houston, TX (US); J. Erik Hellstrom, Houston, TX (US); Jason Schwannecke, Houston, TX (US); Stefanie Mentzer, Houston, TX (US)

(21) Appl. No.: 19/425,148

(22) Filed: Dec. 18, 2025

Related U.S. Application Data
(60) Provisional application No. 63/737,156, filed on Dec. 20, 2024.

(51) Int. Cl. B60R 25/31; B60R 25/01; B60R 25/10; B60R 25/102; B60R 25/23; B60R 25/24; B60R 25/30; B60R 25/33; E05F 15/73; G08B 25/10

(52) U.S. Cl. CPC B60R 25/31; B60R 25/01; B60R 25/1003; B60R 25/102; B60R 25/23; B60R 25/24; B60R 25/305; B60R 25/33; E05F 15/73; G08B 25/10; B60R 2325/101; B60R 2325/205; E05Y 2900/531

(57) ABSTRACT

Methods and systems are described that are configured for managing vehicle access. User credential data that includes one or more user profiles associated with user access rights for accessing the vehicle or one or more compartments of the vehicle may be stored at a computing device of the vehicle. In addition, a user device may store user information for identifying a user of the user device. Based on detecting the user device, the computing device may determine that the user information matches at least one of the user profiles and determine access rights of the user profile. Based on the user access rights, the computing device may cause the vehicle and/or the one or more compartments to unlock. If unauthorized access to the vehicle is detected while the alarm system is armed, the alarm system may enter into breach mode and one or more alarm actions may be implemented.

### CROSS-REFERENCE TO RELATED APPLICATION

This application claims priority to and the benefit of the filing date of U.S. Provisional Ser. No. 63/737,156 , filed Dec. 20, 2024, the entirety of which is hereby incorporated by reference herein.

### BACKGROUND

The field of vehicle security systems for fleet environments faces technical challenges in providing coordinated breach responses across multiple vehicles parked in proximity to one another. When a breach event occurs on a single vehicle in a fleet, conventional alarm systems respond only on the breached vehicle itself. If an intruder disables the alarm system of the breached vehicle, or if the audible alarm is insufficient to attract attention in a remote or isolated location, the breach event may go undetected. This isolated approach to vehicle security may result in delayed response times and increased vulnerability of fleet vehicles to theft or unauthorized access.

Additionally, conventional vehicle security systems may lack the communication infrastructure to coordinate alarm responses among nearby vehicles. In fleet environments where multiple vehicles may be parked together at a job site or depot, the inability to leverage the collective alarm capabilities of nearby vehicles represents a technical limitation. The absence of vehicle-to-vehicle or vehicle-to-cloud communication for security coordination means that the lights, sound devices, and image capture devices of nearby vehicles remain inactive during a breach event on a neighboring vehicle, even though activation of these devices could increase the likelihood of the breach being noticed and recorded from multiple angles.

Furthermore, existing access control systems for commercial vehicles may not provide the granularity of compartment-level access management that fleet operators require. Different users within a fleet operation may have varying levels of training, skill, or authorization, and may therefore require access to different compartments or areas of a vehicle. Conventional systems may not adequately support the dynamic management of access rights based on user credentials, training status, or operator-defined authorization levels, which may result in either overly permissive access or unnecessary restrictions on authorized personnel.

### SUMMARY

It is to be understood that both the following general description and the following detailed description are exemplary and explanatory only and are not restrictive.

Methods, systems, and apparatus for managing vehicle access and implementing coordinated alarm responses across multiple vehicles in a fleet environment are described. A vehicle computing device may store user credential information. The vehicle computing device may determine access rights to the vehicle and its compartments based on user profiles, enabling granular access control where different users may have different levels of access based on skill level, experience, or training. When unauthorized access to the vehicle is detected while an alarm system is armed, the system may initiate one or more alarm actions on the breached vehicle. In addition, the system may communicate with nearby vehicles to trigger coordinated alarm responses, including activating lights, sound devices, and image capture devices across multiple vehicles to increase visibility of the breach event.

In an embodiment, disclosed are methods comprising receiving, by a computing device, user credential information comprising data indicative of one or more user profiles associated with access rights for accessing one or more of a vehicle or one or more compartments of the vehicle, determining a user in proximity to the vehicle, determining, based on the user in proximity to the vehicle, user information that matches at least one user profile of the one or more user profiles, determining, based on the at least one user profile, access rights to one or more of the vehicle or the one or more compartments of the vehicle, and causing, based on the access rights, one or more of the vehicle or the one or more compartments of the vehicle to unlock.

In an embodiment, disclosed are methods comprising causing, by a computing device, based on arming an alarm system of a vehicle to arm, each door of one or more doors of the vehicle and each compartment of one or more compartments of the vehicle to lock, based on detecting unauthorized access to the one or more doors or the one or more compartments while the alarm system is armed, determining unauthorized access to the vehicle, determining, based on the unauthorized access to the vehicle, one or more vehicles in proximity to the vehicle, and causing the one or more vehicles in proximity to the vehicle to initiate one or more alarm actions.

In an embodiment, disclosed are methods comprising causing, by a computing device, based on arming an alarm system of a vehicle to arm, each door of one or more doors of the vehicle and each compartment of one or more compartments of the vehicle to lock, based on detecting unauthorized access to the one or more doors or the one or more compartments while the alarm system is armed, determining unauthorized access to the vehicle, and causing, based on the unauthorized access to the vehicle, the vehicle and one or more vehicles in proximity to the vehicle to initiate one or more alarm actions.

In an embodiment, disclosed are methods comprising causing, by a computing device, based on arming an alarm system of a vehicle to arm, each door of one or more doors of the vehicle and each compartment of one or more compartments of the vehicle to lock, based on detecting unauthorized access to the one or more doors or the one or more compartments while the alarm system is armed, determining unauthorized access to the vehicle, and causing, based on the unauthorized access to the vehicle, the vehicle to initiate one or more alarm actions.

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive.

### BRIEF DESCRIPTION OF THE DRAWINGS

To easily identify the discussion of any particular element or act, the most significant digit or digits in a reference number refer to the figure number in which that element is first introduced.

FIG. 1 shows an example system;

FIG. 2 shows an example process;

FIG. 3 shows an example process;

FIG. 4 shows an example process;

FIG. 5 shows an example process;

FIG. 6 shows an example process;

FIG. 7 shows an example process;

FIGS. 8A-8B show example scenarios;

FIG. 9 shows an example scenario;

FIG. 10 shows a flowchart of an example method;

FIG. 11 shows a flowchart of an example method;

FIG. 12 shows a flowchart of an example method; and

FIG. 13 shows a flowchart of an example method.

### DETAILED DESCRIPTION

Before the present methods and systems are disclosed and described, it is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and the examples included therein and to the Figures and their previous and following description.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

Hereinafter, various embodiments of the present disclosure will be described with reference to the accompanying drawings.

As used herein, the term “user” may indicate a person who uses an electronic device.

As used herein, the terms “arm,” “armed,” “arming,” and the like, in association with a vehicle security/alarm system, may refer to the activation of the vehicle security/alarm system.

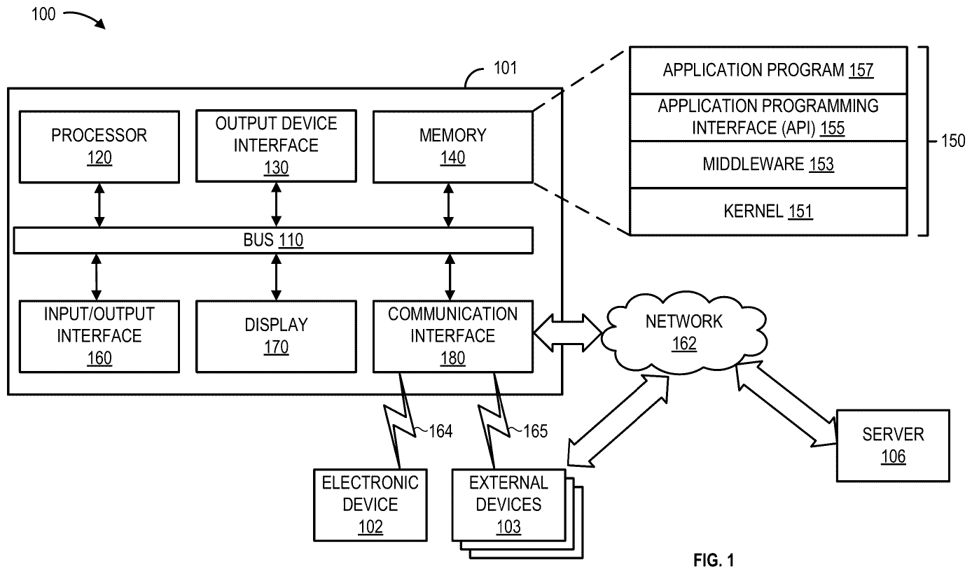

FIG. 1 shows an example system 100 including a vehicle computing device 101 configured for controlling an alarm system of a vehicle and managing vehicle access according to various embodiments. The vehicle computing device 101 may be included in a vehicle (e.g., automobile, truck, SUV, electric vehicle, etc.). Optionally, in exemplary aspects, the vehicle may be a delivery vehicle (e.g., delivery van or delivery truck), a work truck, or other commercial vehicle. The vehicle computing device 101 may include a bus 110, a processor 120, an output device interface 130, a memory 140, an input/output interface 160, a display 170, and a communication interface 180. In an example, the vehicle computing device 101 may omit at least one of the aforementioned constitutional elements or may additionally include other constitutional elements. The vehicle computing device 101 may comprise one or more of a telematics device, an electronic control device, and the like.

The bus 110 may include a circuit for connecting the processor 120, the output device interface 130, the memory 140, the input/output interface 160, the display 170, and the communication interface 180 to each other and for delivering communication (e.g., a control message and/or data) between the processor 120, the output device interface 130, the memory 140, the input/output interface 160, the display 170, and the communication interface 180.

The processor 120 may include one or more of a Central Processing Unit (CPU), an Application Processor (AP), and a Communication Processor (CP). The processor 120 may control, for example, at least one of the output device interface 130, the memory 140, the input/output interface 160, the display 170, and the communication interface 180 and/or may execute an arithmetic operation or data processing for communication. The processing (or controlling) operation of the processor 120 according to various embodiments is described in detail with reference to the following drawings.

The output device interface 130 may be configured to interface with one or more output devices of the vehicle. The one or more output devices may comprise one or more lights (e.g., exterior lights, interior lights, strobe lights, etc.), one or more sound devices (e.g., horn(s), speaker(s), etc.), one or more image capture devices (e.g., one or more video cameras), and/or one or more display devices of the vehicle. For example, the one or more lights, the one or more sound devices, the one or more image capture devices, and/or the one or more display devices may be activated in the event unauthorized access to the vehicle is detected.

The memory 140 may include a volatile and/or non-volatile memory. The memory 130 may store, for example, a command or data related to at least one different constitutional element of the vehicle computing device 101. In an example, the memory 140 may store a software and/or a program 150. The program 150 may include, for example, a kernel 151, a middleware 153, an Application Programming Interface (API) 155, and/or an application program (or an “application”) 157, or the like, configured for controlling one or more functions of the vehicle computing device 101 and/or an external device (e.g., the one or more output device of the vehicle and/or one or more external devices 103 such as external vehicle computing devices of one or more other vehicles in proximity to the vehicle). At least one part of the kernel 151, middleware 153, or API 155 may be referred to as an Operating System (OS). The memory 140 may include a computer-readable recording medium having a program recorded therein to perform the method according to various embodiments by the processor 120.

The kernel 151 may control or manage, for example, system resources (e.g., the bus 110, the processor 120, the memory 140, etc.) used to execute an operation or function implemented in other programs (e.g., the middleware 153, the API 155, or the application program 157). Further, the kernel 151 may provide an interface capable of controlling or managing the system resources by accessing individual constitutional elements of the vehicle computing device 101 in the middleware 153, the API 155, or the application program 157.

The middleware 153 may perform, for example, a mediation role so that the API 155 or the application program 157 can communicate with the kernel 151 to exchange data.

Further, the middleware 153 may handle one or more task requests received from the application program 157 according to a priority. For example, the middleware 153 may assign a priority of using the system resources (e.g., the bus 110, the processor 120, or the memory 140) of the vehicle computing device 101 to at least one of the application programs 157. For example, the middleware 153 may process the one or more task requests according to the priority assigned to at least one of the application programs, and thus, may perform scheduling or load balancing on the one or more task requests.

The API 155 may include at least one interface or function (e.g., instruction), for example, for file control, window control, video processing, or character control, as an interface capable of controlling a function provided by the application 157 in the kernel 151 or the middleware 153.

The application program 157 may include logic (e.g., hardware, software, firmware, etc.) that may be implemented to control the alarm system of the vehicle and manage vehicle access. User credential information may be stored at the vehicle computing device 101 (e.g., in the memory 140 or a database of the vehicle computing device 101). The credential information may comprise data indicative of one or more user profiles associated with access rights for accessing one or more of the vehicle or one or more compartments of the vehicle. For example, one or more components (e.g., engine, transmission, sensors, control modules, etc.) of the vehicle may be stored in the one or more compartments. Access to the one or more compartments may be restricted according to access rights that allow access to the one or more compartments. For example, the access rights may be determined based on one or more levels of access for a user. The one or more levels of access may be determined based one or more of skill level, experience level, or operator training. If a user's access rights do not include access rights to a particular compartment, the user may be prevented from accessing the particular compartment. In an example, the vehicle computing device 101 (e.g., the memory 140 or the database) may be updated remotely (e.g., via a web portal or user application stored at a use device such as electronic device 102) to update the user profiles stored at the vehicle computing device 101. User information of the user may be stored on an electronic device 102 (e.g., user device) such as a card, a mobile device (e.g., cell phone, smart phone, tablet computer, etc.), or a key fob. The vehicle computing device 101 may detect the electronic device 102 as the user carries the electronic device 102 within proximity to the vehicle. Based on detecting the electronic device 102 in proximity to the vehicle, the application program 157 may cause the vehicle computing device 101 to access the detected electronic device 102 and retrieve the user information. In an example, the user information may be linked to a unique code that may be provided via a keypad of the vehicle. As an example, the vehicle computing device 101 may receive user input comprising the unique code. Based on receiving the user input comprising the unique code, the application program 157 may cause the vehicle computing device 101 to retrieve the user information linked to the unique code. In an example, the vehicle computing device 101 may receive a request to access the vehicle and/or the one or more compartments. Based on the request, the application program 157 may cause the vehicle computing device 101 to access the detected electronic device 102 and retrieve the user information. The application program 157 may cause the vehicle computing device 101 to determine that the user information matches at least one user profile of the one or more profiles stored at the vehicle computing device 101. In an example, the unique code may be linked to the at least one user profile, wherein the application program 157 may cause the vehicle computing device 101 to determine that the at least one profile matches one of the profiles stored at the vehicle computing device 101. The application program 157 may cause the vehicle computing device 101 to determine access rights to one or more of the vehicle or the one or more compartments of the vehicle based on the at least one user profile. For example, the application program 157 may cause the vehicle computing device 101 to determine whether the access rights associated with the at least one user profile provides access to one or more of the vehicle or the one or more compartments. Based the access rights, the application program 157 may cause the vehicle computing device 101 to cause one or more of the vehicle (e.g., one or more doors of the vehicle) or the one or more compartments of the vehicle to unlock. In an example, the vehicle may be included in a fleet of vehicles, wherein an owner of the fleet of vehicles may manage access rights to the fleet of vehicles. For example, one or more users (e.g., one or more operators) may send a request (e.g., to the fleet owner's user device, computing device, server device, etc.) for additional access rights (e.g., to one or more additional compartments of the vehicle). It may be determined if the additional access rights are approved. For example, it may be determine whether the one or more users possess required training for accessing one or more of the compartments of the vehicle. If one or more of the users do not have the required training, access to one or more of the compartments may be prevented. However, if one or more of the users complete the required training, access to one or more of the compartments may be provided. In an example, the fleet owner may have administrative rights to provide or revoke access rights to one or more of the users.

In an example, the application program 157 may cause the vehicle computing device 101 to cause the alarm system to arm based on receiving user input (e.g., via the input/output interface 160). For example, the user may provide user input to the electronic device 102 to cause the electronic device 102 to send a signal to the vehicle computing device 101 to cause the vehicle computing device 101 to activate and arm the alarm system. As an example, the display device 170 may display an arm status of the alarm system and/or the vehicle. The vehicle computing device 101 may detect one or more conditions associated with the vehicle while the alarm system is armed. The one or more conditions may comprise one or more of unauthorized access to a door of the vehicle or unauthorized access to a compartment of the vehicle. Based on detecting the one or more conditions, the application program 157 may cause the vehicle computing device 101 to determine unauthorized access to the vehicle. For example, an individual that does not have access rights to the vehicle may attempt to open one or more doors of the vehicle and/or one or compartments of the vehicle. For example, the vehicle computing device 101 may detect that an electronic device of the individual attempting to access the vehicle and/or the one or more compartments does not contain user information that matches any of the user profiles, stored at the vehicle computing device 101, that are associated with access rights to the vehicle and/or the one or more compartments. Based on the unauthorized access to the vehicle, the application program 157 may cause the vehicle computing device 101 to cause the vehicle to initiate one or more first alarm actions. The one or more first alarm actions may comprise closing and locking one or more open doors of the vehicle, closing and locking one or more open compartments of the vehicle, activating one or more lights of the vehicle, activating one or more sound devices of the vehicle, sending one or more notifications to one or more users, sending a message to law enforcement, outputting an alert message on a display of the vehicle, activating one or more image capture devices for recording video, or causing one or more vehicles in proximity to the vehicle to activate one or more lights and one or more sound devices of the one or more vehicles. As an example, one or more notifications may be sent to the fleet owner and/or one or more users (e.g., one or more operators) of the vehicle indicating unauthorized access to the vehicle and GPS coordinates of the vehicle. For example, the one or more notifications may comprise an indication of the breached vehicle, an identifier of the breached vehicle, a date and time of the breach, and/or GPS coordinates of the vehicle. A user device (e.g., via a dashboard portal or via text message) of the fleet owner may display the notification to the fleet owner. As another example, a message may be sent to law enforcement informing law enforcement of the unauthorized access to the vehicle and GPS coordinates of the vehicle. For example, the message may comprise an indication of the breached vehicle, a date and time of the breach, and/or GPS coordinates of the vehicles along with a clickable link (e.g., a URL) to at least one mapping service.

In an example, the vehicle may only include manual locking mechanisms. Thus, the vehicle does not lock the doors and/or the one or more compartments when the alarm system is armed or when detecting unauthorized access of the vehicle. As an example, the or more first alarm actions for a vehicle with manual locking mechanisms may comprise activating one or more lights of the vehicle, activating one or more sound devices of the vehicle, sending one or more notifications to one or more users, sending a message to law enforcement, outputting an alert message on a display of the vehicle, activating one or more image capture devices for recording video, or causing one or more vehicles in proximity to the vehicle to activate one or more lights and one or more sound devices of the one or more vehicles.

In an example, the application program 157 may cause the vehicle computing device 101 to determine one or more vehicles in proximity to the vehicle based on the unauthorized access to the vehicle. For example, the vehicle computing device 101 may determine the one or more vehicles in proximity to the vehicle based on one or more communication signals associated with the one or more vehicles. The one or more communication signals may comprise a vehicle-to-cloud communication signal or a vehicle-to-vehicle communication signal. The vehicle-to-cloud communication signal may comprise GPS location signals of the one or more vehicles. The vehicle-to-vehicle communication signal may comprise a dedicated short-range communications (DSRC) signal, a cellular peer-to-peer signal, a Bluetooth signal, or a Wi-Fi signal. The application program 157 may cause the vehicle computing device 101 to access the vehicle computing devices 103 of the one or more vehicles to cause the one or more vehicles to perform one or more second alarm actions. The one or more second alarm actions may comprise one or more of closing and locking one or more open doors of the one or more vehicles, closing and locking one or more open compartments of the one or more vehicles, activating one or more lights of the one or more vehicles, activating one or more sound devices of the one or more vehicles, activating one or more image capture devices for recording video, or outputting an alert message on a display of the one or more vehicles. In an example, if any of the one or more vehicles only contain manual locking mechanisms, the one or more second alarm actions for the vehicles that only contain manual locking mechanisms may comprise one or more of activating one or more lights of the one or more vehicles, activating one or more sound devices of the one or more vehicles, activating one or more image capture devices for recording video, or outputting an alert message on a display of the one or more vehicles. In an example, one or more lights of the one or more vehicles in proximity to the vehicle and one or more lights of the vehicle may be activated and flash according to one or more patterns. In an example, the one or more lights of the one or more vehicles in proximity to the vehicle may activate, or flash, according to a pattern that differs from the one or more lights of the vehicle. The application program 157 may cause the vehicle computing device 101 to cause the vehicle to discontinue the one or more alarm actions based on authorized access to the vehicle. For example, the user may provide user input at the electronic device 102 (wherein the electronic device 102 is authenticated) to send a signal to the vehicle computing device 101 to cause the vehicle computing device 101 deactivate the alarm system. The user may subsequently provide input, via the electronic device 102, to send a signal to the vehicle computing device 101 to cause the vehicle computing device 101 to activate and arm the alarm system.

The input/output interface 150 may be configured as an interface for delivering an instruction or data input from a user or a different external device(s) to the processor 120, the memory 140, the input/output interface 160, the display 170, and the communication interface 180. Further, the input/output interface 160 may output an instruction or data received from the processor 120, the memory 140, the input/output interface 160, the display 170, and/or the communication interface 180 to a different external device.

The display 170 may include various types of displays, such as, for example, a Liquid Crystal Display (LCD) display, a Light Emitting Diode (LED) display, an Organic Light-Emitting Diode (OLED) display, a MicroElectroMechanical Systems (MEMS) display, or an electronic paper display. The display 170 may display, for example, a variety of contents (e.g., text, image, video, icon, symbol, etc.) to the user. The display 170 may include a touch screen. For example, the display 170 may receive a touch, gesture, proximity, or hovering input by using a stylus pen or a part of a user's body. In an example, the display 170 may comprise a visual interface for configuring the alarm system of the vehicle. In an example, the display 170 may output one or more alert messages associated with unauthorized access to the vehicle.

The communication interface 180 may establish, for example, communication between the vehicle computing device 101 and an external device (e.g., the electronic device 102, the external devices 103 such as the external vehicle computing devices, or a server 106). For example, the communication interface 180 may communicate with the external device (e.g., the external devices 103 and/or the server 106) by being connected to a network 162 via wireless communication or wired communication. For example, as a cellular communication protocol, the wireless communication may use at least one of Long-Term Evolution (LTE), LTE Advance (LTE-A), Code Division Multiple Access (CDMA), Wideband CDMA (WCDMA), Universal Mobile Telecommunications System (UMTS), Wireless Broadband (WiBro), Global System for Mobile Communications (GSM), and the like. In an example, the network 162 may include, for example, at least one of a telecommunications network, a computer network (e.g., LAN or WAN), the internet, and a telephone network.

In addition, the communication interface 180 may communicate with the external device (e.g., the electronic device 102 and/or the external devices 103 via communication path 165) via wireless communication or wired communication. The wireless communication 164, 165 may include, for example, a near-distance communication. The near-distance communications 164, 165 may include, for example, at least one of Wireless Fidelity (WiFi), Bluetooth, Near Field Communication (NFC), Global Navigation Satellite System (GNSS), and the like. According to a usage region or a bandwidth or the like, the GNSS may include, for example, at least one of Global Positioning System (GPS), Global Navigation Satellite System (Glonass), Beidou Navigation Satellite System (hereinafter, “Beidou”), Galileo, the European global satellite-based navigation system, and the like. Hereinafter, the “GPS” and the “GNSS” may be used interchangeably in the present document. The wired communication 164, 165 may include, for example, at least one of Universal Serial Bus (USB), High Definition Multimedia Interface (HDMI), Recommended Standard-232 (RS-232), power-line communication, Plain Old Telephone Service (POTS), and the like.

The server 106 may comprise a group of one or more servers. In an example, all or some of the operations executed by the vehicle computing device 101 may be executed in a different one or a plurality of electronic devices (e.g., the electronic device 102, the external devices 104, or the server 106). In an example, if the vehicle computing device 101 needs to perform a certain function or service either automatically or based on a request, the vehicle computing device 101 may request at least some parts of functions related thereto alternatively or additionally to a different electronic device (e.g., the electronic device 102, the external devices 104, or the server 106) instead of executing the function or the service autonomously. The different electronic devices (e.g., the electronic device 102, the external devices 104, or the server 106) may execute the requested function or additional function, and may deliver a result thereof to the vehicle computing device 101. The vehicle computing device 101 may provide the requested function or service either directly or by additionally processing the received result. For example, a cloud computing, distributed computing, or client-server computing technique may be used.

The system 100 provides a technical improvement to the technical problem of vehicle security in fleet environments where multiple vehicles may be parked in proximity to one another. Conventional vehicle alarm systems may operate in isolation, wherein a breach of one vehicle may go unnoticed if the alarm of the breached vehicle is disabled or if the alarm is not sufficiently audible to attract attention. The system 100 may address this technical problem by enabling coordinated alarm responses across multiple vehicles in proximity to a breached vehicle. For example, when unauthorized access to a vehicle is detected, the vehicle computing device 101 may communicate with vehicle computing devices 103 of one or more vehicles in proximity to the breached vehicle to cause the one or more vehicles to initiate alarm actions. This coordinated response may increase the likelihood that the breach event is noticed by activating lights, sound devices, and image capture devices on multiple vehicles rather than relying solely on the alarm system of the breached vehicle. In some aspects, the system 100 may provide a technical improvement by enabling the image capture devices of multiple vehicles to record video of the surrounding environment, which may capture different angles and perspectives of the breach event. In some cases, the system 100 may provide a technical improvement by enabling differentiated alarm patterns, wherein the lights of the breached vehicle may flash according to a first pattern and the lights of the one or more vehicles in proximity may flash according to a second pattern that differs from the first pattern, thereby enabling identification of the breached vehicle among the multiple vehicles with activated alarms.

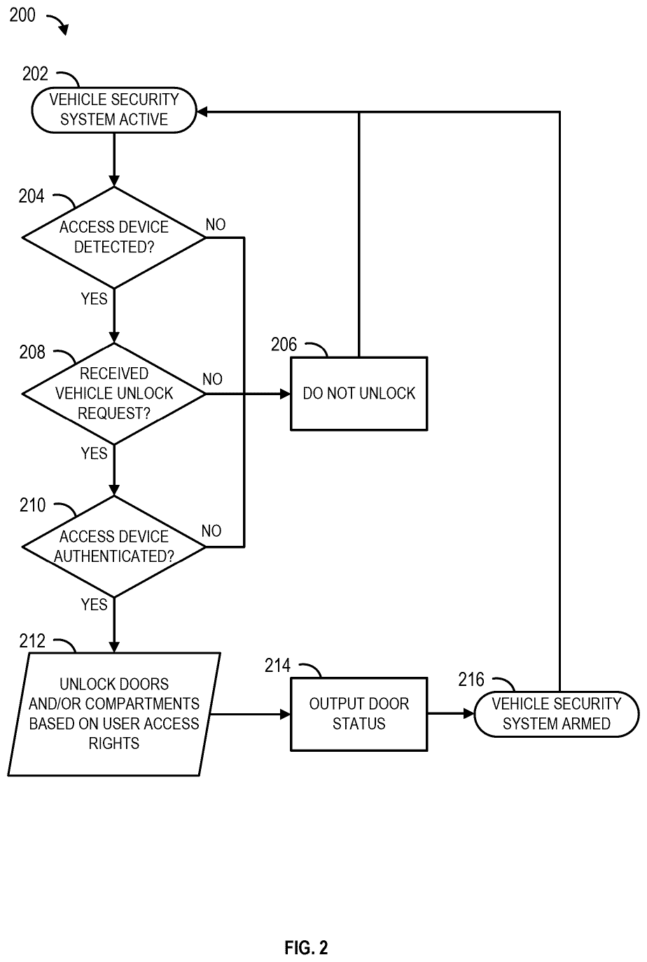

FIG. 2 shows an example process 200 for determining whether a user has access rights to a vehicle and/or one or more compartments of the vehicle. The method 200 may be implemented by a computing device such as vehicle computing device 101, one or more output devices of the vehicle, a user device 102, one or more external vehicle computing devices 103, combinations thereof, and the like. At 202, the vehicle security/alarm system may be active. At 204, it may be determined whether an access device (e.g., electronic user device 102) is detected in proximity to the vehicle. For example, user information of the user may be stored on the access device. The access device may comprise one or more of a card, a mobile device (e.g., cell phone, smart phone, tablet computer, etc.), or a key fob. In an example, the user information may be linked to a unique code that may be provided via a keypad of the vehicle. As an example, user input comprising the unique code may be received. Based on receiving the user input comprising the unique code, the user information linked to the unique code may be retrieved. If the access device is not detected in proximity to the vehicle, the vehicle and/or the one or more compartments may remain locked at 206. The vehicle security system may remain active and continue to monitor for the access device at 202. If the access device is detected within proximity to the vehicle, it may be determined whether a request to unlock the vehicle and/or one or more of the compartments has been received at 208. In an example, if the user input comprising the unique code is received, it may be determined whether a request to unlock the vehicle and/or one or more of the compartments has been received at 208. If a request to unlock the vehicle and/or one or more of the compartments has not been received, the vehicle and/or the one or more compartments may remain locked at 206.

If a request to unlock the vehicle and/or one or more of the compartments has been received, it may be determined whether the access device can be authenticated at 210. For example, user credential information may be stored at a computing device (e.g., vehicle computing device 101) of the vehicle. The credential information may comprise data indicative of one or more user profiles associated with access rights for accessing one or more of the vehicle or one or more compartments of the vehicle. Access to the vehicle and/or the one or more compartments may be restricted according to access rights that allow access to the vehicle and/or the one or more compartments. For example, the access rights may be determined based on one or more levels of access for a user. The one or more levels of access are determined based one or more of skill level, experience level, or operator training. If a user's access rights do not include access rights to a particular compartment, the user may be prevented from accessing the particular compartment. The user information may be retrieved from the access device and matched to at least one of the user profiles. The access device may be authenticated based on the user information matching at least one of the user profiles. In an example, it may be determined that the user information may be determined based on the unique code and matched to at least one of the user profiles. A user that provided the user input comprising the unique code may be authenticated based on the user information linked to the unique code matching at least one of the user profiles. If the access device cannot be authenticated, the vehicle and/or the one or more compartments may remain locked at 206. In an example, if the user cannot be authenticated based on the unique code, the vehicle and/or the one or more compartments may remain locked at 206. If the access device can be authenticated, the vehicle (e.g., one or more doors of the vehicle) and/or one or more of the compartments may be unlocked based on the access rights at 212. In an example, if the user can be authenticated based on the unique code, the vehicle and/or one or more of the compartments may be unlocked based on the access rights at 212. At 214, door and/or compartment status (e.g., opened status or closed status) data may be sent to a vehicle human machine interface (HMI) of the vehicle and/or the cloud, for example. At 216, the vehicle security/alarm system may be armed, wherein the vehicle security/alarm system may be activated and may continue to monitor for the access device at 202. For example, a user may provide user input, after completing one or more tasks and exiting the vehicle, to the access device to cause the access device to send a signal to the computing device to cause the computing device to arm vehicle security/alarm system.

The process 200 provides a technical improvement to the technical problem of managing access control in fleet environments where different users may require different levels of access to vehicle compartments. Conventional vehicle access systems may provide uniform access to all compartments once a user is authenticated, which may not adequately address scenarios where certain compartments contain specialized equipment or hazardous materials that require specific training or authorization to access. The process 200 may address this technical problem by enabling granular access control based on user profiles that reflect skill level, experience level, or operator training. For example, when a user's access device is detected and authenticated at 210, the process 200 may determine the specific access rights associated with the user's profile and unlock only those compartments for which the user has authorization at 212. This approach may prevent unauthorized access to compartments containing equipment that the user is not trained to operate, while still permitting access to compartments appropriate for the user's authorization level. In some aspects, the process 200 may provide a technical improvement by enabling real-time status reporting at 214, wherein door and compartment status data may be transmitted to a vehicle HMI and/or cloud-based systems, allowing fleet operators to monitor access events and maintain records of which users accessed which compartments at what times.

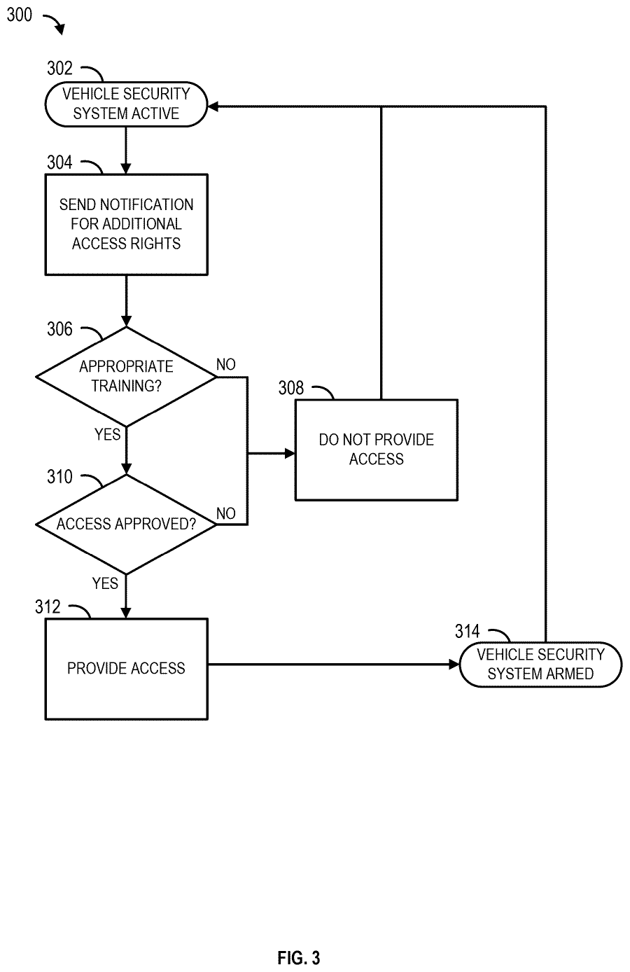

FIG. 3 shows an example process 300 for managing access to one or more compartments of a vehicle. The method 300 may be implemented by a computing device such as vehicle computing device 101, one or more output devices of the vehicle, a user device 102, one or more external vehicle computing devices 103, combinations thereof, and the like. At 302, the vehicle security/alarm system may be active. At 304, a user may send a notification requesting additional access rights. For example, the vehicle may be included in a fleet of vehicles, wherein an owner of the fleet of vehicles may manage access rights to the fleet of vehicles. At 306, it may be determined if the user has appropriate training credentials. If the user does not have the appropriate training, access may be prevented at 308. The vehicle security system may remain active and continue to monitor for the access device at 302. If the user has the appropriate training, it may be determined whether access is approved at 310. For example, the user may not have access to the requested vehicle and/or a requested compartment of the vehicle based on the user lacking a required skill level or experience level. If the user is not approved, access may be prevented at 308. If the user is approved, access may be provided at 312. At 314, the vehicle security/alarm system may be armed, wherein the vehicle security/alarm system may be activated and may continue to monitor for the access device at 302. For example, a user may provide user input, after completing one or more tasks and exiting the vehicle, to the access device to cause the access device to send a signal to the a computing device (e.g., vehicle computing device 101) of the vehicle to cause the computing device to arm the vehicle security/alarm system.

The process 300 provides a technical improvement to the technical problem of dynamically managing access rights in fleet environments where user qualifications and authorization levels may change over time. Conventional vehicle access systems may rely on static access configurations that do not accommodate requests for expanded access rights or verification of training credentials in real-time. The process 300 may address this technical problem by enabling a workflow for requesting and evaluating additional access rights based on training credentials and approval status. For example, when a user sends a notification requesting additional access rights at 304, the process 300 may verify whether the user possesses appropriate training credentials at 306 before determining whether access is approved at 310. This approach may enable fleet operators to maintain control over which users can access specific compartments while providing a mechanism for users to request expanded access as their training or qualifications change. In some aspects, the process 300 may provide a technical improvement by separating the training credential verification at 306 from the access approval determination at 310, which may allow fleet operators to implement multi-factor authorization where a user may possess the required training but still require explicit approval from a fleet owner or administrator before access is granted. In some cases, the process 300 may provide a technical improvement by enabling the vehicle security/alarm system to remain active throughout the access request workflow, thereby maintaining security monitoring while access rights are being evaluated.

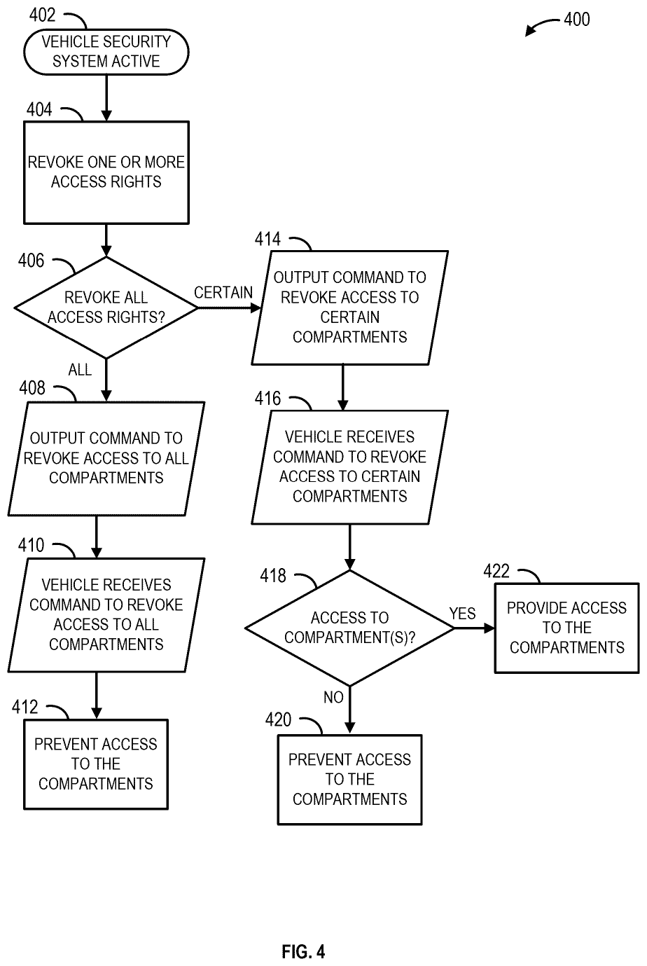

FIG. 4 shows an example process 400 for managing access to one or more compartments of a vehicle. The method 400 may be implemented by a computing device such as vehicle computing device 101, one or more output devices of the vehicle, a user device 102, one or more external vehicle computing devices 103, combinations thereof, and the like. At 402, the vehicle security/alarm system may be active. At 404, one or more access rights may be revoked. For example, the vehicle may be included in a fleet of vehicles, wherein an owner of the fleet of vehicles may manage access rights to the fleet of vehicles. At 406, it is determined whether all access rights are revoked or whether some access rights are revoked (e.g., for access to all of the compartments or just some of the compartments).

If all access rights are revoked, a command to revoke access to all of the compartments of the vehicle may be output at 408. For example, a computing device of the fleet owner may output the command to revoke access to all of the compartments. At 410, the vehicle may receive the command to revoke access to all of the compartments, wherein the vehicle may prevent access to the compartments at 412.

If only some access rights are revoked, a command to revoke access to some of the compartments of the vehicle may be output at 414. For example, the computing device of the fleet owner may output the command to revoke access to some of the compartments. At 410, the vehicle may receive the command to revoke access to some of the compartments. At 418, it may be determined whether a user seeking to access one or more of the compartments has access to the compartments. If the user does not have access to the requested compartment(s), access may be prevented to the requested compartment(s) at 420. If the user has access to the requested compartment(s), access may be provided to the requested compartment(s) at 422.

The process 400 provides a technical improvement to the technical problem of managing access revocation in fleet environments where user authorization status may need to be modified in response to changing circumstances. Conventional vehicle access systems may not provide mechanisms for remotely revoking access rights or may only support complete revocation of all access rather than selective revocation of access to specific compartments. The process 400 may address this technical problem by enabling fleet operators to selectively revoke access rights at varying levels of granularity. For example, when access rights are revoked at 404, the process 400 may determine at 406 whether all access rights or only some access rights are being revoked, and may output corresponding commands at 408 or 414 to implement the appropriate level of revocation. This approach may enable fleet operators to respond to situations where a user's authorization to access certain compartments should be removed while maintaining the user's access to other compartments. In some aspects, the process 400 may provide a technical improvement by enabling real-time enforcement of access revocation, wherein the vehicle may receive and implement revocation commands while the vehicle security/alarm system remains active at 402. In some cases, the process 400 may provide a technical improvement by enabling compartment-level access verification at 418, which may allow the system to evaluate each access request against the current access rights configuration after a partial revocation has been implemented.

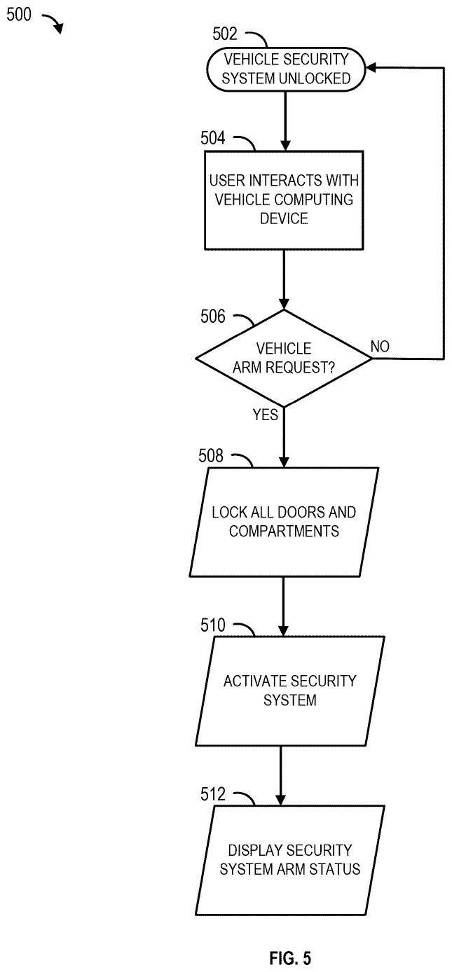

FIG. 5 shows an example process 500 for arming an alarm system of a vehicle. The method 500 may be implemented by a computing device such as vehicle computing device 101, one or more output devices of the vehicle, a user device 102, one or more external vehicle computing devices 103, combinations thereof, and the like. At 502, the vehicle security/alarm system may be deactivated and the vehicle and/or one or more compartments of the vehicle may be unlocked. At 504, a user may interact with a computing device (e.g., vehicle computing device 101) of the vehicle. At 506 it may be determined whether a vehicle security/alarm system arm request was received by the vehicle from the user (e.g., via an electronic device 102 of the user). If an arm request was not received, the vehicle security/alarm system may remain deactivated and the vehicle and/or the one or more compartments may remain unlocked at 502. If an arm request was received, all of the doors of the vehicles and all of the compartments of the vehicle may be locked at 508. At 510, the vehicle security/alarm system may be activated. At 512, a display of the vehicle may display an arm status of the vehicle security/alarm system.

The process 500 may provide a technical improvement to the technical problem of ensuring consistent security state transitions in vehicle alarm systems. Conventional vehicle alarm systems may not provide confirmation of successful arming or may not verify that all access points are secured before activating the alarm system, which may result in situations where the alarm system is armed while doors or compartments remain unlocked or open. The process 500 may address this technical problem by implementing a sequential workflow that locks all doors and compartments at 508 before activating the security system at 510. This approach may help ensure that the vehicle is in a fully secured state before the alarm system begins monitoring for unauthorized access. In some aspects, the process 500 may provide a technical improvement by displaying the arm status at 512, which may provide visual confirmation to the user that the arming sequence has completed successfully. In some cases, the process 500 may provide a technical improvement by requiring explicit user interaction at 504 and an arm request at 506 before initiating the arming sequence, which may help prevent accidental arming of the vehicle security system while authorized users are still accessing the vehicle or its compartments.

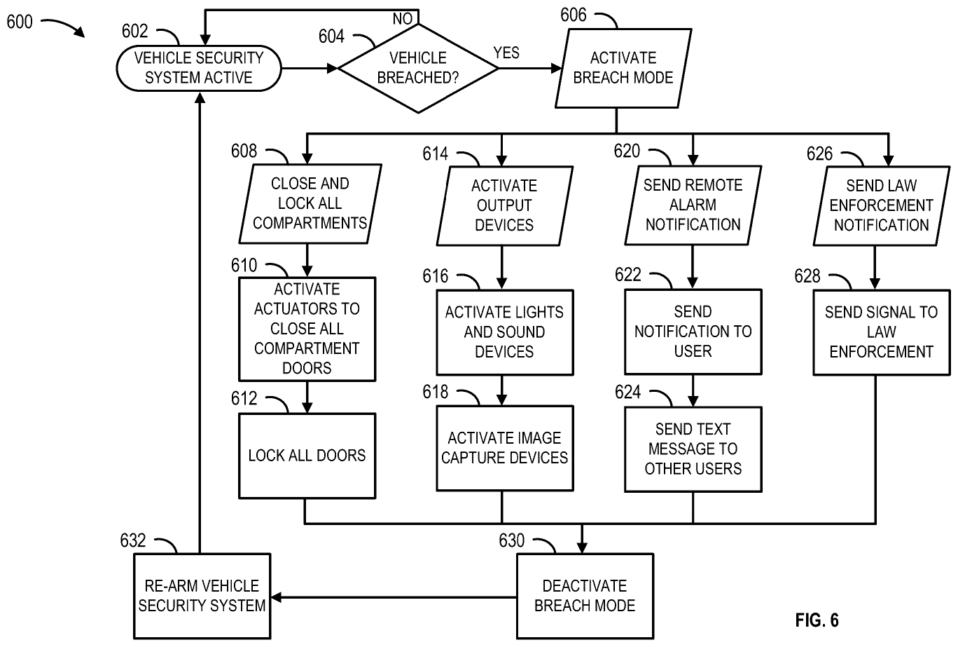

FIG. 6 shows an example process 600 for implementing one or more alarm actions based on detecting unauthorized access to a vehicle. The method 600 may be implemented by a computing device such as vehicle computing device 101, one or more output devices of the vehicle, a user device 102, one or more external vehicle computing devices 103, combinations thereof, and the like. At 602, the vehicle security/alarm system may be active. At 604, it may be determined if the vehicle was breached. For example, it may be determined if unauthorized access to the vehicle was detected. If the vehicle was not breached, the vehicle security/alarm system may remain active and continue to monitor for unauthorized access to the vehicle at 602. If the vehicle was breached, the vehicle security/alarm system may activate a breach mode at 606. All compartments of the vehicle may be closed and locked at 608. For example, the compartments may comprise actuators configured to open and close the compartment doors and locking mechanisms to lock the compartment doors. As such, at 610, the actuators may be activated to close the compartment doors. In addition, the locking mechanisms may be activated to lock the compartment doors at 612. At 614, one or more output devices of the vehicle may be activated. For example, the one or more output devices may comprise one or more exterior lights, one or more interior lights, one or more horns, and/or one or more speakers of the vehicle. As such, at 616, one or more of the exterior lights, interior lights, horns, and speakers of the vehicle may be activated. At 618, one or more image capture devices (e.g., video cameras) of the vehicle may be activated. For example, one or more interior or exterior image capture devices of the vehicle may be activated in order to start recording video of the surrounding environment. At 620, one or more remote alarm notifications may be sent/output. For example, the vehicle may be included in a fleet of vehicles, wherein an owner of the fleet of vehicles may access vehicle status (e.g., via a dashboard portal via a computing device of the fleet owner). One or more of the alarm notifications may be sent to the fleet owner at 622, which may include GPS coordinates of the vehicle. For example, the one or more alarm notifications may comprise an indication of the breached vehicle, an identifier of the breached vehicle, a date and time of the breach, and/or GPS coordinates of the vehicle. At 624, one or more of the alarm notifications may be sent to one or more users (e.g., one or more operators) of the vehicle. At 626, a law enforcement notification may be sent/output, wherein an SOS signal may be sent to law enforcement at 628. For example, the SOS signal may comprise an indication of the breached vehicle, a date and time of the breach, and/or GPS coordinates of the vehicles along with a clickable link (e.g., a URL) to at least one mapping service.

At 630, the breach mode may be deactivated. For example, the user of the vehicle may deactivate the breach mode (e.g., via an electronic device 102) after inspecting the vehicle and determining that the vehicle breach event has discontinued or was a false alarm. At 632, the vehicle security/alarm system may be re-armed (e.g., via an authenticated electronic device 102), wherein the vehicle security/alarm system may remain active and continue to monitor for unauthorized access to the vehicle at 602.

The process 600 may provide a technical improvement to the technical problem of responding to vehicle breach events in a comprehensive and coordinated manner. Conventional vehicle alarm systems may provide limited response capabilities, such as activating only a single audible alarm or sending a notification to a single recipient, which may not adequately address breach events in remote locations or situations where rapid response is desirable. The process 600 may address this technical problem by implementing a multi-layered response that includes securing the vehicle, activating multiple output devices, capturing video evidence, and notifying multiple parties. For example, when a breach is detected at 604, the process 600 may activate breach mode at 606 and proceed to close and lock all compartments at 608 through 612, which may help prevent further unauthorized access or theft of contents. In some aspects, the process 600 may provide a technical improvement by activating multiple output devices at 614 through 616, including exterior lights, interior lights, horns, and speakers, which may increase the likelihood that the breach event is noticed by individuals in the vicinity of the vehicle. In some cases, the process 600 may provide a technical improvement by activating image capture devices at 618 to record video of the surrounding environment, which may provide evidence that can be used to identify individuals involved in the breach event. The process 600 may also provide a technical improvement by sending notifications to multiple parties at 620 through 628, including the fleet owner, vehicle operators, and law enforcement, which may enable a coordinated response to the breach event. In some aspects, the inclusion of GPS coordinates and clickable links to mapping services in the notifications may facilitate rapid location of the breached vehicle by responding parties.

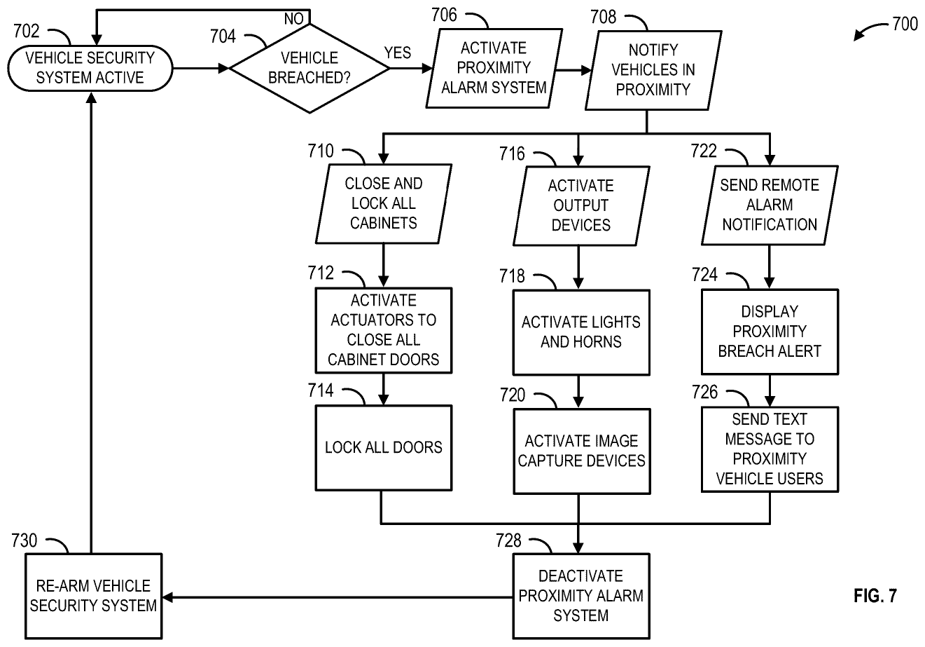

FIG. 7 shows an example process 700 for implementing one or more alarm actions based on detecting unauthorized access to a vehicle. The method 700 may be implemented by a computing device such as vehicle computing device 101, one or more output devices of the vehicle, a user device 102, one or more external vehicle computing devices 103, combinations thereof, and the like. At 702, the vehicle security/alarm system may be active. At 704, it may be determined if the vehicle was breached. For example, it may be determined if unauthorized access to the vehicle was detected. If the vehicle was not breached, the vehicle security/alarm system may remain active and continue to monitor for unauthorized access to the vehicle at 702. If the vehicle was breached, a proximity alarm system may be activated at 706, wherein one or more vehicles in proximity to the vehicle may be notified of the vehicle breach event at 708. All compartments of the one or more vehicles in proximity to the vehicle may be closed and locked at 710. For example, the compartments may comprise actuators configured to open and close the compartment doors and locking mechanisms to lock the compartment doors. As such, at 712, the actuators may be activated to close the compartment doors. In addition, the locking mechanisms may be activated to lock the compartment doors at 714. At 716, one or more output devices of the one or more vehicles in proximity to the vehicle may be activated. For example, the one or more output devices may comprise one or more exterior lights, one or more interior lights, one or more horns, and/or one or more speakers of the one or more vehicles in proximity to the vehicle. As such, at 718, one or more of the exterior lights, interior lights, horns, and speakers of the one or more vehicles in proximity to the vehicle may be activated. At 720, one or more image capture devices (e.g., video cameras) of the one or more vehicles in proximity to the vehicle may be activated. For example, one or more interior or exterior image capture devices of the one or more vehicles in proximity to the vehicle may be activated in order to start recording video of the surrounding environment. At 722, one or more remote alarm notifications may be sent/output, wherein a proximity breach alert may be displayed on displays of each of the one or more vehicles in proximity to the vehicle at 724 and one or more text messages may be sent to users (e.g., operators) of the one or more vehicles in proximity to the vehicle at 726. For example the vehicle, in addition to the one or more vehicles in proximity to the vehicle, may be included in a fleet of vehicles, wherein an owner of the fleet of vehicles may access vehicle status (e.g., via a dashboard portal via a user device) data of the vehicle and the one or more vehicles in proximity to the vehicle. At 728, the proximity alarm system may be deactivated. For example, the user of the vehicle may deactivate the proximity alarm system (e.g., via an authenticated electronic device 102) after inspecting the vehicle and determining that the vehicle breach event has discontinued or was a false alarm. At 730, the vehicle security/alarm system may be re-armed (e.g., via an authenticated electronic device 102), wherein the vehicle security/alarm system may remain active and continue to monitor for unauthorized access to the vehicle at 702.

The process 700 provides a technical improvement to the technical problem of coordinating alarm responses across multiple vehicles in fleet environments where vehicles may be parked in proximity to one another. Conventional vehicle alarm systems may operate in isolation, wherein a breach event on one vehicle may go unnoticed if the alarm of the breached vehicle is disabled or if the audible alarm is insufficient to attract attention in a remote or isolated location. The process 700 may address this technical problem by enabling a proximity alarm system that extends the alarm response beyond the breached vehicle to include nearby vehicles in the fleet. For example, when a breach is detected at 704, the process 700 may activate the proximity alarm system at 706 and notify nearby vehicles at 708, which may cause the nearby vehicles to initiate their own alarm actions. In some aspects, the process 700 may provide a technical improvement by closing and locking compartments on the nearby vehicles at 710 through 714, which may help prevent opportunistic unauthorized access to multiple vehicles during a breach event. In some cases, the process 700 may provide a technical improvement by activating output devices on the nearby vehicles at 716 through 718, including lights, horns, and speakers, which may increase the overall visibility and audibility of the alarm response and may attract attention from individuals in the vicinity who might not have noticed the alarm from the breached vehicle alone. The process 700 may also provide a technical improvement by activating image capture devices on the nearby vehicles at 720, which may enable video recording of the breach event from multiple angles and perspectives, potentially capturing evidence that would not be available from the image capture devices of the breached vehicle alone. In some aspects, the process 700 may provide a technical improvement by displaying proximity breach alerts on the displays of nearby vehicles at 724 and sending text messages to operators of nearby vehicles at 726, which may enable rapid awareness and response from fleet personnel who may be in or near the nearby vehicles.

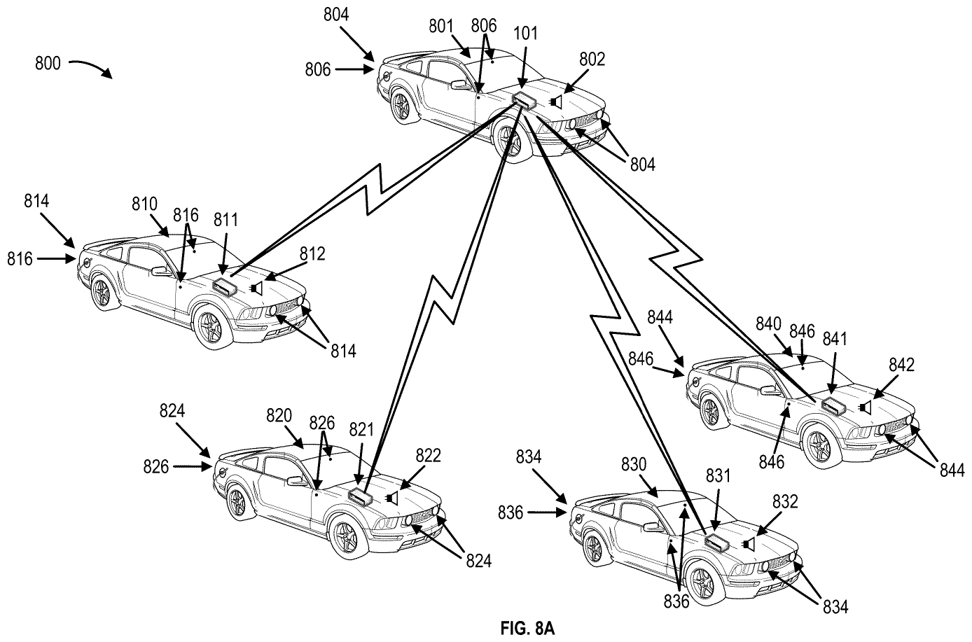

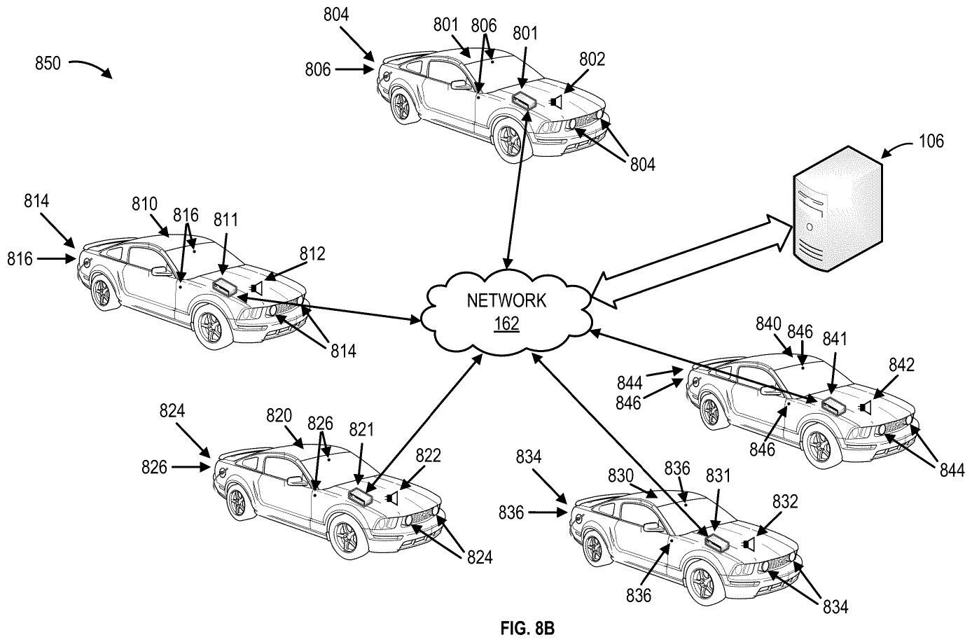

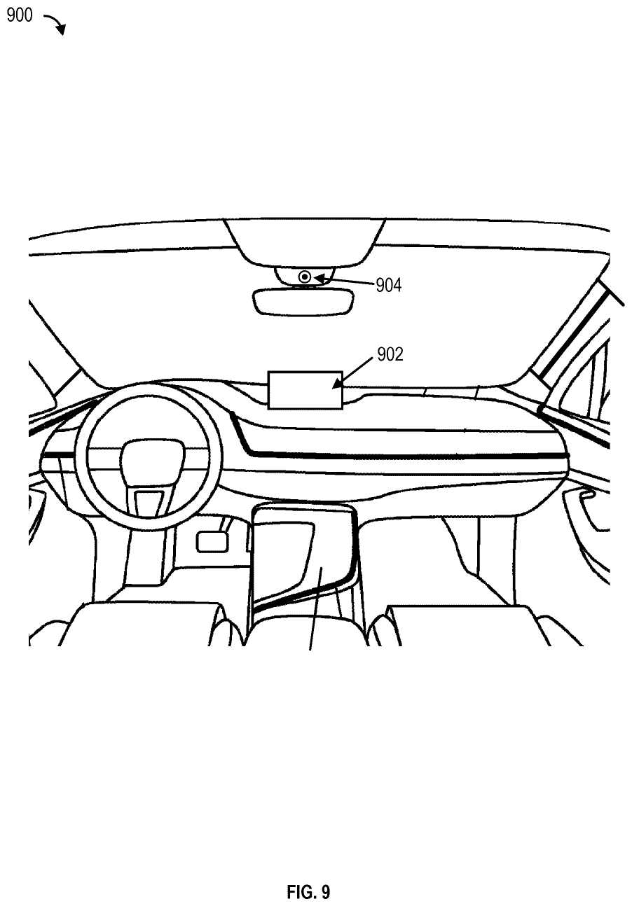

FIGS. 8A-8B show example scenarios 800, 850 associated with implementing the one or more alarm actions. In an example, an alarm system of a vehicle 801 may be armed, wherein each door of one or more doors of the vehicle 801 and each compartment of one or more compartments of the vehicle 801 may be locked based on arming the alarm system. For example, the user may provide input to a user device (e.g., an electronic device 102 such as a card, a mobile device (e.g., cell phone, smart phone, tablet computer, etc.) to cause the user device send a signal to a vehicle computing device 101 of the vehicle 801 to cause the vehicle computing device 101 to activate and arm the alarm system. Based on detecting unauthorized access to the one or more doors or the one or more compartments while the alarm system is armed, the vehicle computing device 101 may determine unauthorized access to the vehicle 801. For example, an individual that does not have access rights to the vehicle 801 may attempt to open one or more doors of the vehicle 801 and/or one or compartments of the vehicle 801. For example, the vehicle computing device 101 may detect that an access device of the individual attempting to access the vehicle 801 and/or the one or more compartments does not contain user information that matches any user profiles, stored at the vehicle computing device 101, that are associated with access rights to the vehicle 801. In an example, the vehicle computing device 101 may determine that user input, comprising a unique code, received from the individual attempting to access the vehicle 801 and/or the one or more compartments is not associated with user information (e.g., user information linked to the unique code) that matches any user profiles, stored at the vehicle computing device 101, that are associated with access rights to the vehicle 801. Based on the unauthorized access to the vehicle 801, the vehicle computing device 101 may cause the vehicle 801 and/or one or more vehicles 810, 820, 830, 840 in proximity to the vehicle 801 to initiate one or more alarm actions. For example, the vehicle computing device 101 may cause the vehicle 801 to close and lock one or more open compartments of the vehicle 801, activate one or more lights 804 of the vehicle 801, activate one or more sound devices 802 of the vehicle 801, send one or more notifications to one or more users, send a message to law enforcement, output an alert message on a display of the vehicle 801, activate one or more image capture devices 806 for recording video, or cause the one or more vehicles 810, 820, 830, 840 to activate one or more lights 814, 824, 834, 844, one or more sound devices 812, 822, 832, 842, and/or one or more image capture devices 816, 826, 836, 846 of the one or more vehicles 810, 820, 830, 840. For example, the vehicle computing device 101 may cause the one or more vehicles 810, 820, 830, 840 to close and lock one or more open doors of the one or more vehicles 810, 820, 830, 840, close and lock one or more open compartments of the one or more vehicles 810, 820, 830, 840, activate one or more lights 814, 824, 834, 844, activate one or more sound devices 812, 822, 832, 842, activate one or image capture devices 816, 826, 836, 846, or output an alert message on a display of the one or more vehicles 810, 820, 830, 840. In an example, as shown in FIG. 9, each of the vehicles 801, 810, 820, 830, 840 may include a display 902 that may display an alert message based on the unauthorized access to the vehicle and/or an interior image capture device 904 that may be activated in order record to video of the interior of the vehicles 801, 810, 820, 830, 840.

The vehicle computing device may determine the one or more vehicles 810, 820, 830, 840 in proximity to the vehicle 801 based on one or more communication signals associated with the one or more vehicles 810, 820, 830, 840. The one or more communication signals may comprise a vehicle-to-cloud communication signal or a vehicle-to-vehicle communication signal (e.g., via vehicle computing devices 811, 821, 831, 841). In an example, as shown in FIG. 8A, the vehicle-to-vehicle communication signal may comprise a DSRC signal, cellular peer-to-peer signal, Bluetooth, or Wi-Fi signal. In an example, as shown in FIG. 8B, the vehicle-to-cloud communication signal may comprise a GPS location signal associated with each of the one or more vehicles 810, 820, 830, 840. For example, software in the cloud (e.g., server 106) may determine the nearby vehicles 810, 820, 830, 840 based on known GPS positions of the nearby vehicles 810, 820, 830, 840 and send messages (e.g., via network 162) to the nearby vehicles 810, 820, 830, 840.

The alarm system described in FIGS. 8A-8B may provide a technical improvement to the technical problem of limited alarm visibility and evidence capture in fleet environments where a single vehicle's alarm system may be insufficient to deter unauthorized access or attract attention. Conventional vehicle alarm systems may rely solely on the output devices of the breached vehicle, which may be disabled by an intruder or may not be audible in remote or noisy environments. The alarm system may address this technical problem by enabling the vehicle computing device 101 of the breached vehicle 801 to communicate with vehicle computing devices 811, 821, 831, 841 of nearby vehicles 810, 820, 830, 840 to coordinate alarm responses across multiple vehicles. In some aspects, the scenario 800 may provide a technical improvement by utilizing vehicle-to-vehicle communication signals such as DSRC, cellular peer-to-peer, Bluetooth, or Wi-Fi signals to directly notify nearby vehicles without requiring cloud connectivity, which may enable faster response times and may function in areas with limited network coverage. In some cases, the scenario 850 may provide a technical improvement by utilizing vehicle-to-cloud communication via the server 106 and network 162, which may enable coordination of alarm responses based on GPS positions of vehicles in the fleet, potentially extending the proximity alarm functionality to vehicles that may not be within direct communication range of the breached vehicle. The scenarios 800, 850 may also provide a technical improvement by enabling activation of image capture devices 806, 816, 826, 836, 846 across multiple vehicles, which may capture video of the breach event from multiple angles and perspectives, thereby increasing the likelihood of obtaining useful evidence for identifying individuals involved in the unauthorized access attempt.

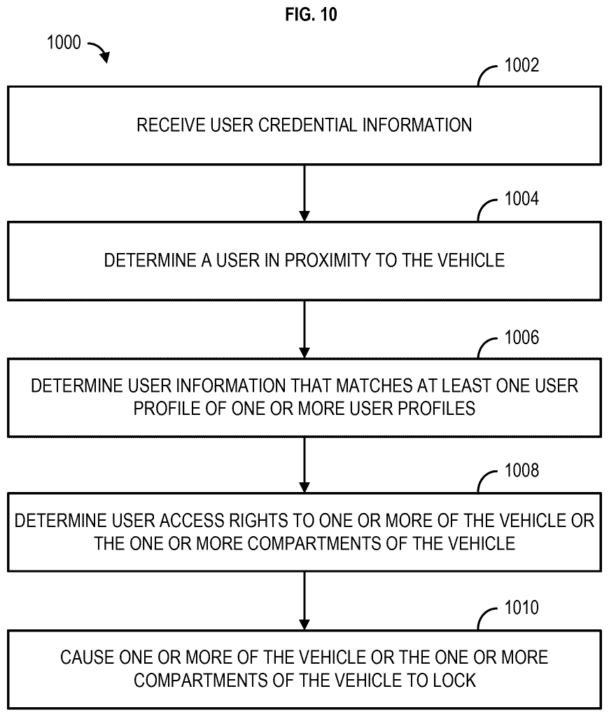

FIG. 10 shows a flowchart for an example method 1000 for controlling access to a vehicle and/or one or more compartments of the vehicle. The method 1000 may be implemented by a computing device such as vehicle computing device 101, one or more output devices of the vehicle, a user device 102, one or more external vehicle computing devices 103, combinations thereof, and the like. At step 1002, user credential information comprising data indicative of one or more user profiles associated with access rights for accessing one or more of a vehicle or one or more compartments of the vehicle may be received. For example, a computing device (e.g. vehicle computing device 101) may receive the user credential information comprising data indicative of the one or more user profiles associated with access rights for accessing one or more of the vehicle or the one or more compartments of the vehicle. The access rights may be based on one or more levels of access for a user. The one or more levels of access may be determined based one or more of skill level, experience level, or operator training. The user credential information may be stored at the computing device (e.g., in memory or a database of the computing device). In an example, the computing device (e.g., the memory or the database) may be updated remotely (e.g., via a web portal or user application stored at a use device) to update the user profiles stored at the computing device.

At step 1004, a user device may be detected in proximity to the vehicle. For example, the computing device (e.g. vehicle computing device 101) may detect the user device in proximity to the vehicle. The user device may comprise one or more of a card, a mobile device (e.g., cell phone, smart phone, tablet computer, etc.), or a key fob. As an example, the computing device may detect the user device as the user carries the user device within proximity to the vehicle.

At step 1006, user information that matches at least one user profile of the one or more user profiles may be determined based on accessing the detected user device. For example, the computing device (e.g. vehicle computing device 101) may determine that the user information matches the at least one user profile of the one or more user profiles based on accessing the detected user device. The user information may be stored at the user device. As an example, based on detecting the user device in proximity to the vehicle, the computing device may access the detected user device and retrieve the user information from the user device. In an example, the user information may be linked to a unique code that may be provided via a keypad of the vehicle. As an example, user input comprising the unique code may be received. Based on receiving the user input comprising the unique code, the user information linked to the unique code may be retrieved. In an example, the computing device may receive a request to access the vehicle and/or the one or more compartments. Based on the request, the computing device access the detected user device and retrieve the user information. In an example, the unique code may be linked to the at least one user profile, wherein it may be determined the at least one profile matches the one or more user profiles.

At step 1008, access rights to one or more of the vehicle or the one or more compartments of the vehicle may be determined based on the at least one user profile. For example, the computing device (e.g. vehicle computing device 101) may determine the access rights to one or more of the vehicle or the one or more compartments of the vehicle. For example, the computing device may determine whether the access rights associated with the at least one user profile provides access to one or more of the vehicle or one or more of the compartments.

At step 1010, one or more of the vehicle or the one or more compartments of the vehicle may be unlocked based on the access rights. For example, the computing device (e.g. vehicle computing device 101) may cause one or more of the vehicle or the one or more compartments of the vehicle to unlock based on the access rights. In an example, an alarm system of the vehicle may be armed and each compartment of the one or more compartments of the vehicle may be locked based on user input. For example, the user may provide the user input to the user device, wherein the user device may provide a signal to the computing device to cause the computing device to activate and arm the alarm system. As an example, a display device of the vehicle may output an arm status of the vehicle.

In an example, unauthorized access to the vehicle may be determined based on detecting one or more conditions. The one or more conditions may comprise one or more of unauthorized access to a door of the vehicle or unauthorized access to a compartment of the vehicle. For example, an individual that does not have access rights to the vehicle may attempt to open one or more doors of the vehicle and/or one or compartments of the vehicle. For example, the computing device may detect that a user device of the individual attempting to access the vehicle and/or the one or more compartments does not contain user information that matches any user profiles, stored at the computing device, that are associated with access rights to the vehicle. In an example, the computing device may determine that user input, comprising a unique code, received from the individual attempting to access the vehicle and/or the one or more compartments is not associated with user information (e.g., user information linked to the unique code) that matches any user profiles, stored at the computing device, that are associated with access rights to the vehicle. The vehicle may be caused to initiate one or more first alarm actions based on the unauthorized access to the vehicle. The one or more first alarm actions may comprise closing and locking one or more open doors of the vehicle, closing and locking one or more open compartments of the vehicle, activating one or more lights of the vehicle, activating one or more sound devices of the vehicle, sending one or more notifications to one or more users, sending a message to law enforcement, outputting an alert message on a display of the vehicle, activating one or more image capture devices for recording video, or causing one or more vehicles in proximity to the vehicle to activate one or more lights and one or more sound devices of the one or more vehicles.

In an example, one or more vehicles in proximity to the vehicle may be determined based on the unauthorized access to the vehicle and based on one or more communication signals associated with one or more vehicles. The one or more communication signals may comprise a vehicle-to-cloud communication signal or a vehicle-to-vehicle communication signal. The vehicle-to-cloud communication signal may comprise GPS location signals of the one or more vehicles. The vehicle-to-vehicle communication signal may comprises a DSRC signal, a cellular peer-to-peer signal, a Bluetooth signal, or a Wi-Fi signal. The one or more vehicles in proximity to the vehicle may be caused to perform one or more second alarm actions. The one or more second alarm actions may comprise one or more of closing and locking one or more open doors of the one or more vehicles, closing and locking one or more open compartments of the one or more vehicles, activating one or more lights of the one or more vehicles, activating one or more sound devices of the one or more vehicles, activating one or more image capture devices for recording video, or outputting an alert message on a display of the one or more vehicles. In an example, the vehicle may be caused to discontinue the one or more first alarm actions and/or the one or more second alarm actions based on authorized access to the vehicle. For example, a user may provide input to the user device, that is authenticated, to cause the user device to send a signal to the computing device to cause the computing device to deactivate the alarm system and discontinue the one or more first alarm actions and/or the one or more second alarm actions.

The method 1000 described in FIG. 10 provides a technical improvement to the technical problem of managing granular access control in fleet environments where different users may require different levels of access to vehicle compartments based on their qualifications, training, or authorization status. Conventional vehicle access systems may provide uniform access to all compartments once a user is authenticated, which may not adequately address scenarios where certain compartments contain specialized equipment, hazardous materials, or high-value cargo that require specific training or authorization to access. The method 1000 may address this technical problem by enabling the computing device to receive user credential information that includes user profiles with associated access rights, detect a user device in proximity to the vehicle, match user information to a user profile, determine access rights based on the matched user profile, and unlock only those compartments for which the user has authorization. In some aspects, the method 1000 may provide a technical improvement by enabling access rights to be determined based on one or more levels of access that reflect skill level, experience level, or operator training, which may allow fleet operators to implement differentiated access policies that restrict access to compartments containing equipment that a user is not trained to operate while still permitting access to compartments appropriate for the user's authorization level. In some cases, the method 1000 may provide a technical improvement by enabling remote updates to user profiles stored at the computing device via a web portal or user application, which may allow fleet operators to dynamically modify access rights in response to changes in user qualifications or authorization status without requiring physical access to the vehicle.

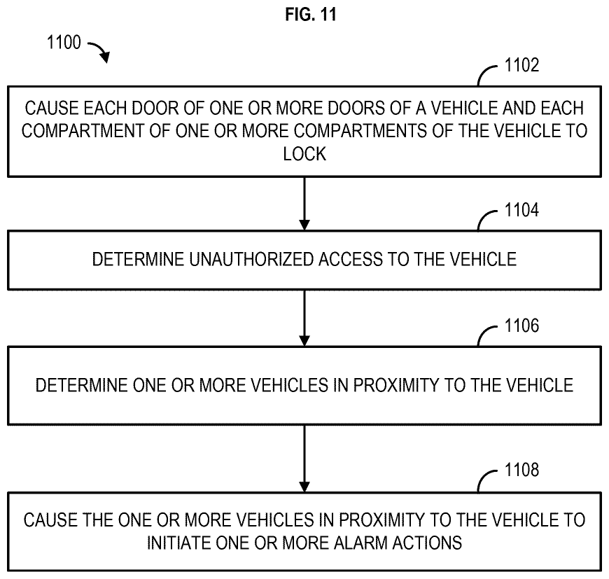

FIG. 11 shows a flowchart for an example method 1100 for implementing one or more alarm actions based on detecting unauthorized access to a vehicle. The method 1100 may be implemented by a computing device such as vehicle computing device 101, one or more output devices of the vehicle, a user device 102, one or more external vehicle computing devices 103, combinations thereof, and the like. At step 1102, each door of one or more doors of a vehicle and each compartment of one or more compartments of the vehicle may be locked based on arming an alarm system of the vehicle. For example, a computing device (e.g. vehicle computing device 101) may cause each door of the one or more doors of the vehicle and each compartment of the one or more compartments of the vehicle to lock based on arming the alarm system of the vehicle. For example, a user may provide user input to a user device, wherein the user device may provide a signal to the computing device to cause the computing device to activate and arm the alarm system.

At step 1104, unauthorized access to the vehicle may be determined based on detecting unauthorized access to the one or more doors or the one or more compartments while the alarm system is armed. For example, the computing device (e.g. vehicle computing device 101) may determine unauthorized access to the vehicle based on detecting unauthorized access to the one or more doors or the one or more compartments while the alarm system is armed. For example, an individual that does not have access rights to the vehicle may attempt to open one or more doors of the vehicle and/or one or compartments of the vehicle. For example, the computing device may detect that a user device of the individual attempting to access the vehicle and/or the one or more compartments does not contain user information that matches any user profiles, stored at the computing device, that are associated with access rights to the vehicle. In an example, the computing device may determine that user input, comprising a unique code, received from the individual attempting to access the vehicle and/or the one or more compartments is not associated with user information (e.g., user information linked to the unique code) that matches any user profiles, stored at the computing device, that are associated with access rights to the vehicle.

At step 1106, one or more vehicles in proximity to the vehicle may be determined based on the unauthorized access to the vehicle. For example, the computing device (e.g. vehicle computing device 101) may determine the one or more vehicles in proximity to the vehicle based on the unauthorized access to the vehicle. As an example, the computing device may detect the one or more vehicles in proximity to the vehicle based on one or more communication signals associated with the one or more vehicles. The one or more communication signals may comprise a vehicle-to-cloud communication signal or a vehicle-to-vehicle communication signal. The vehicle-to-cloud communication signal may comprise GPS location signals of the one or more vehicles. The vehicle-to-vehicle communication signal may comprises a DSRC signal, a cellular peer-to-peer signal, a Bluetooth signal, or a Wi-Fi signal.

At step 1108, the one or more vehicles in proximity to the vehicle may be caused to initiate one or more first alarm actions. For example, computing device (e.g. vehicle computing device 101) may cause the one or more vehicles in proximity to the vehicle to initiate the one or more first alarm actions. The one or more first alarm actions may comprise one or more of closing and locking one or more open doors of the one or more vehicles, closing and locking one or more open compartments of the one or more vehicles, activating one or more lights of the one or more vehicles, activating one or more sound devices of the one or more vehicles, activating one or more image capture devices for recording video, or outputting an alert message on a display of the one or more vehicles. In an example, the vehicle may be caused to initiate one or more second alarm actions based on the unauthorized access to the vehicle. The one or more second alarm actions may comprise one or more of closing and locking one or more open doors of the one or more vehicles, closing and locking one or more open compartments of the one or more vehicles, activating one or more lights of the one or more vehicles, activating one or more sound devices of the one or more vehicles, activating one or more image capture devices for recording video, or outputting an alert message on a display of the one or more vehicles. As an example, the one or more lights of the one or more vehicles may be activated in a pattern that differs from a pattern of one or more lights of the vehicle. In an example, the vehicle may be caused to discontinue the one or more first alarm actions and/or the one or more second alarm actions based on authorized access to the vehicle. For example, a user may provide input to the user device, that is authenticated, to cause the user device to send a signal to the computing device to cause the computing device to deactivate the alarm system and discontinue the one or more first alarm actions and/or the one or more second alarm actions.

The method 1100 described in FIG. 11 provides a technical improvement to the technical problem of coordinating alarm responses across multiple vehicles in fleet environments where vehicles may be parked in proximity to one another. Conventional vehicle alarm systems may operate in isolation, wherein a breach event on one vehicle may not trigger any response from nearby vehicles, even when those nearby vehicles could contribute to deterring unauthorized access or capturing evidence of the breach event. The method 1100 may address this technical problem by enabling the computing device to lock all doors and compartments when the alarm system is armed, detect unauthorized access, determine one or more vehicles in proximity to the breached vehicle, and cause the nearby vehicles to initiate alarm actions. In some aspects, the method 1100 may provide a technical improvement by enabling the activation of lights, sound devices, and image capture devices across multiple vehicles, which may increase the visibility and audibility of the alarm response and may enable video recording of the breach event from multiple angles and perspectives. In some cases, the method 1100 may provide a technical improvement by enabling differentiated alarm patterns, wherein the lights of the nearby vehicles may be activated in a pattern that differs from the pattern of the lights of the breached vehicle, which may allow responding parties to identify which vehicle in a group of alarming vehicles is the breached vehicle. In some aspects, the method 1100 may provide a technical improvement by utilizing vehicle-to-cloud or vehicle-to-vehicle communication signals to determine nearby vehicles, which may enable coordination of alarm responses without requiring pre-configuration of vehicle groupings or manual identification of nearby vehicles at the time of a breach event.

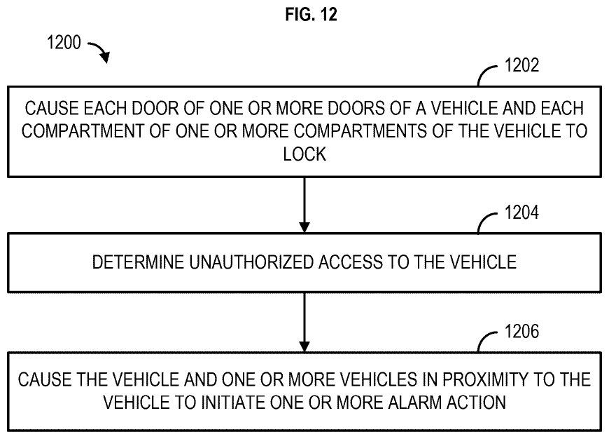

FIG. 12 shows a flowchart for an example method 1200 for implementing one or more alarm actions based on detecting unauthorized access to a vehicle. The method 1200 may be implemented by a computing device such as vehicle computing device 101, one or more output devices of the vehicle, a user device 102, one or more external vehicle computing devices 103, combinations thereof, and the like. At step 1202, each door of one or more doors of a vehicle and each compartment of one or more compartments of the vehicle may be locked based on arming an alarm system of the vehicle. For example, a computing device (e.g. vehicle computing device 101) may cause each door of the one or more doors of the vehicle and each compartment of the one or more compartments of the vehicle to lock based on arming the alarm system of the vehicle. For example, a user may provide user input to a user device, wherein the user device may provide a signal to the computing device to cause the computing device to activate and arm the alarm system.

At step 1204, unauthorized access to the vehicle may be determined based on detecting unauthorized access to the one or more doors or the one or more compartments while the alarm system is armed. For example, the computing device (e.g. vehicle computing device 101) may determine unauthorized access to the vehicle based on detecting unauthorized access to the one or more doors or the one or more compartments while the alarm system is armed. For example, an individual that does not have access rights to the vehicle may attempt to open one or more doors of the vehicle and/or one or compartments of the vehicle. For example, the computing device may detect that a user device of the individual attempting to access the vehicle and/or the one or more compartments does not contain user information that matches any user profiles, stored at the computing device, that are associated with access rights to the vehicle. In an example, the computing device may determine that user input, comprising a unique code, received from the individual attempting to access the vehicle and/or the one or more compartments is not associated with user information (e.g., user information linked to the unique code) that matches any user profiles, stored at the computing device, that are associated with access rights to the vehicle.

At step 1206, the vehicle and one or more vehicles in proximity to the vehicle may be caused to initiate one or more alarm actions based on the unauthorized access to the vehicle. For example, the computing device (e.g. vehicle computing device 101) may cause the vehicle and the one or more vehicles in proximity to the vehicle to initiate the one or more alarm actions based on the unauthorized access to the vehicle. As an example, the computing device may detect the one or more vehicles in proximity to the vehicle based on one or more communication signals associated with the one or more vehicles. The one or more communication signals may comprise a vehicle-to-cloud communication signal or a vehicle-to-vehicle communication signal. The vehicle-to-cloud communication signal may comprise GPS location signals of the one or more vehicles. The vehicle-to-vehicle communication signal may comprises a DSRC signal, a cellular peer-to-peer signal, a Bluetooth signal, or a Wi-Fi signal. The one or more alarm actions may comprise one or more of closing and locking one or more open doors, closing and locking one or more open compartments, activating one or more lights, activating one or more sound devices, outputting an alert message on a display, activating one or more image capture devices for recording video, or sending one or more notifications to one or more users, sending a message to law enforcement. In an example, causing the vehicle and the one or more vehicles in proximity to the vehicle to initiate the one or more alarm actions based on the unauthorized access to the vehicle may comprise causing one or more lights of the one or more vehicles to activate according to a pattern that differs from a pattern of one or more lights of the vehicle based on the unauthorized access to the vehicle. In an example, the vehicle may be caused to discontinue the one or more alarm actions based on authorized access to the vehicle. For example, a user may provide input to the user device, that is authenticated, to cause the user device to send a signal to the computing device to cause the computing device to deactivate the alarm system and discontinue the one or more alarm actions.

The method 1200 described in FIG. 12 provides a technical improvement to the technical problem of responding to vehicle breach events in fleet environments where a single vehicle's alarm response may be insufficient to deter unauthorized access or attract attention. Conventional vehicle alarm systems may respond only on the breached vehicle itself, which may limit the effectiveness of the alarm response if the breached vehicle is in a remote location, if the alarm is not sufficiently audible, or if an intruder disables the alarm system of the breached vehicle. The method 1200 may address this technical problem by enabling the computing device to lock all doors and compartments when the alarm system is armed, detect unauthorized access, and cause both the breached vehicle and nearby vehicles to initiate alarm actions. In some aspects, the method 1200 may provide a technical improvement by enabling simultaneous activation of alarm actions on the breached vehicle and nearby vehicles, which may increase the overall visibility and audibility of the alarm response compared to activating alarm actions on the breached vehicle alone. In some cases, the method 1200 may provide a technical improvement by enabling differentiated light activation patterns, wherein the lights of the nearby vehicles may activate according to a pattern that differs from the pattern of the lights of the breached vehicle, which may assist responding parties in identifying the breached vehicle among multiple vehicles with activated alarms. In some aspects, the method 1200 may provide a technical improvement by enabling the activation of image capture devices across multiple vehicles, which may capture video of the breach event from multiple angles and perspectives that would not be available from the image capture devices of the breached vehicle alone. In some cases, the method 1200 may provide a technical improvement by enabling notifications to be sent to users and law enforcement as part of the alarm actions, which may facilitate a coordinated response to the breach event.

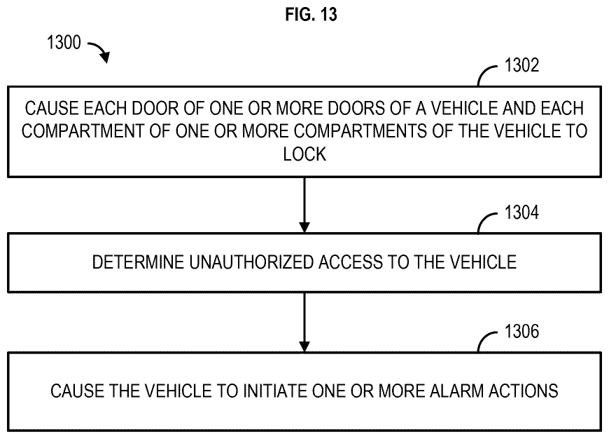

FIG. 13 shows a flowchart for an example method 1300 for implementing one or more alarm actions based on detecting unauthorized access to a vehicle. The method 1300 may be implemented by a computing device such as vehicle computing device 101, one or more output devices of the vehicle, a user device 102, one or more external vehicle computing devices 103, combinations thereof, and the like. At step 1302, each door of one or more doors of a vehicle and each compartment of one or more compartments of the vehicle may be locked based on arming an alarm system of the vehicle. For example, a computing device (e.g. vehicle computing device 101) may cause each door of the one or more doors of the vehicle and each compartment of the one or more compartments of the vehicle to lock based on arming the alarm system of the vehicle. For example, a user may provide user input to a user device, wherein the user device may provide a signal to the computing device to cause the computing device to activate and arm the alarm system.

At step 1304, unauthorized access to the vehicle may be determined based on detecting unauthorized access to the one or more doors or the one or more compartments while the alarm system is armed. For example, the computing device (e.g. vehicle computing device 101) may determine unauthorized access to the vehicle based on detecting unauthorized access to the one or more doors or the one or more compartments while the alarm system is armed. For example, an individual that does not have access rights to the vehicle may attempt to open one or more doors of the vehicle and/or one or compartments of the vehicle. For example, the computing device may detect that a user device of the individual attempting to access the vehicle and/or the one or more compartments does not contain user information that matches any user profiles, stored at the computing device, that are associated with access rights to the vehicle. In an example, the computing device may determine that user input, comprising a unique code, received from the individual attempting to access the vehicle and/or the one or more compartments is not associated with user information (e.g., user information linked to the unique code) that matches any user profiles, stored at the computing device, that are associated with access rights to the vehicle.

At step 1306, the vehicle may be caused to initiate one or more first alarm actions based on the unauthorized access to the vehicle. For example, the computing device (e.g. vehicle computing device 101) may cause the vehicle to initiate the one or more first alarm actions based on the unauthorized access to the vehicle. The one or more first alarm actions comprise closing and locking one or more open doors of the vehicle, closing and locking one or more open compartments of the vehicle, activating one or more lights of the vehicle, activating one or more sound devices of the vehicle, sending one or more notifications to one or more users, sending a message to law enforcement, outputting an alert message on a display of the vehicle, activating one or more image capture devices for recording video, or causing one or more vehicles in proximity to the vehicle to activate one or more lights and one or more sound devices of the one or more vehicles.

In an example, one or more vehicles in proximity to the vehicle may be determined based on the unauthorized access to the vehicle and based on one or more communication signals associated with one or more vehicles. The one or more communication signals may comprise a vehicle-to-cloud communication signal or a vehicle-to-vehicle communication signal. The vehicle-to-cloud communication signal may comprise GPS location signals of the one or more vehicles. The vehicle-to-vehicle communication signal may comprises a DSRC signal, a cellular peer-to-peer signal, a Bluetooth signal, or a Wi-Fi signal. The one or more vehicles in proximity to the vehicle may be caused to perform one or more second alarm actions. The one or more second alarm actions may comprise one or more of closing and locking one or more open doors of the one or more vehicles, closing and locking one or more open compartments of the one or more vehicles, activating one or more lights of the one or more vehicles, activating one or more sound devices of the one or more vehicles, activating one or more image capture devices for recording video, or outputting an alert message on a display of the one or more vehicles. In an example, the vehicle may be caused to discontinue the one or more first alarm actions and/or the one or more second alarm actions based on authorized access to the vehicle. For example, a user may provide input to the user device, that is authenticated, to cause the user device to send a signal to the computing device to cause the computing device to deactivate the alarm system and discontinue the one or more first alarm actions and/or the one or more second alarm actions.

The method 1300 described in FIG. 1300 provides a technical improvement to the technical problem of implementing comprehensive alarm responses on a breached vehicle while enabling coordinated responses from nearby vehicles in fleet environments. Conventional vehicle alarm systems may provide limited alarm functionality that does not adequately secure the vehicle or notify relevant parties when unauthorized access is detected. The method 1300 may address this technical problem by enabling the computing device to lock all doors and compartments when the alarm system is armed, detect unauthorized access, and cause the vehicle to initiate alarm actions that include both local responses on the breached vehicle and coordination with nearby vehicles. In some aspects, the method 1300 may provide a technical improvement by enabling the breached vehicle to initiate a comprehensive set of first alarm actions that include securing the vehicle by closing and locking open doors and compartments, activating lights and sound devices to attract attention, activating image capture devices to record evidence, and sending notifications to users and law enforcement. In some cases, the method 1300 may provide a technical improvement by enabling the breached vehicle to cause nearby vehicles to perform second alarm actions, which may extend the alarm response beyond the breached vehicle and increase the likelihood that the breach event is noticed and recorded from multiple perspectives. In some aspects, the method 1300 may provide a technical improvement by enabling differentiated alarm actions between the breached vehicle and nearby vehicles, wherein the first alarm actions on the breached vehicle may differ from the second alarm actions on nearby vehicles, which may allow responding parties to distinguish the breached vehicle from vehicles that are participating in the coordinated alarm response.

For purposes of illustration, application programs and other executable program components are illustrated herein as discrete blocks, although it is recognized that such programs and components can reside at various times in different storage components. An implementation of the described methods can be stored on or transmitted across some form of computer readable media. Any of the disclosed methods can be performed by computer readable instructions embodied on computer readable media. Computer readable media can be any available media that can be accessed by a computer. By way of example and not meant to be limiting, computer readable media can comprise “computer storage media” and “communications media.” “Computer storage media” can comprise volatile and non-volatile, removable and non-removable media implemented in any methods or technology for storage of information such as computer readable instructions, data structures, program modules, or other data. Exemplary computer storage media can comprise RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

1. A method comprising:
receiving, by a computing device, user credential information comprising data indicative of one or more user profiles associated with access rights for accessing one or more of a vehicle or one or more compartments of the vehicle;
determining a user in proximity to the vehicle;
determining, based on the user in proximity to the vehicle, user information that matches at least one user profile of the one or more user profiles;
determining, based on the at least one user profile, access rights to one or more of the vehicle or the one or more compartments of the vehicle; and
causing, based on the access rights, one or more of the vehicle or the one or more compartments of the vehicle to unlock.

2. The method of claim 1, wherein the access rights are determined based on one or more levels of access for the user, wherein the one or more levels of access are determined based one or more of a skill level, experience level, or operator training.

3. The method of claim 1, wherein determining the user in proximity to the vehicle comprises detecting a user device in proximity to the vehicle, wherein the user device is associated with the user, wherein the user device comprises one or more of a card, a mobile device, or a key fob, and wherein determining, based on the user in proximity to the vehicle, the user information that matches the at least one user profile of the one or more user profiles comprises determining, based on accessing the detected user device, the user information that matches the at least one user profile of the one or more user profiles.

4. The method of claim 1, wherein determining the user in proximity to the vehicle comprises receiving, via a keypad of the vehicle, user input comprising a unique code, and wherein determining, based on the user in proximity to the vehicle, the user information that matches the at least one user profile of the one or more user profiles comprises determining, based on the user input comprising the unique code, the user information that matches the at least one user profile of the one or more user profiles.

5. The method of claim 1, further comprising:
causing, based on user input, an alarm system of the vehicle to arm and each compartment of the one or more compartments of the vehicle to lock; and
causing a display device of the vehicle to output an arm status of the vehicle.

6. The method of claim 1, further comprising:
based on detecting one or more conditions, determining unauthorized access to the vehicle, wherein the one or more conditions comprise one or more of unauthorized access to a door of the vehicle or unauthorized access to a compartment of the vehicle; and
causing, based on the unauthorized access to the vehicle, the vehicle to initiate one or more alarm actions.

7. The method of claim 6, wherein the one or more alarm actions comprise closing and locking one or more open doors of the vehicle, closing and locking one or more open compartments of the vehicle, activating one or more lights of the vehicle, activating one or more sound devices of the vehicle, sending one or more notifications to one or more users, sending a message to law enforcement, outputting an alert message on a display of the vehicle, activating one or more image capture devices for recording video, or causing one or more vehicles in proximity to the vehicle to activate one or more lights and one or more sound devices of the one or more vehicles.

8. The method of claim 6, further comprising:
determining, based on the unauthorized access to the vehicle and based on one or more communication signals associated with one or more vehicles in proximity to the vehicle, the one or more vehicles in proximity to the vehicle, wherein the one or more communication signals comprise one or more of GPS location signals of the one or more vehicles, a DSRC signal, a cellular peer-to-peer signal, a Bluetooth signal, or a Wi-Fi signal; and
causing the one or more vehicles in proximity to the vehicle to perform one or more second alarm actions.

9. The method of claim 8, wherein the one or more second alarm actions comprise one or more of closing and locking one or more open doors of the one or more vehicles, closing and locking one or more open compartments of the one or more vehicles, activating one or more lights of the one or more vehicles, activating one or more sound devices of the one or more vehicles, activating one or more image capture devices of the one or more vehicles for recording video, or outputting an alert message on a display of the one or more vehicles.

10. A method comprising:
causing, by a computing device, based on arming an alarm system of a vehicle, each door of one or more doors of the vehicle and each compartment of one or more compartments of the vehicle to lock;
based on detecting unauthorized access to the one or more doors or the one or more compartments while the alarm system is armed, determining unauthorized access to the vehicle;
determining, based on the unauthorized access to the vehicle, one or more vehicles in proximity to the vehicle; and
causing the one or more vehicles in proximity to the vehicle to initiate one or more alarm actions.

11. The method of claim 10, wherein determining the one or more vehicles in proximity to the vehicle comprises detecting, based on one or more communication signals associated with the one or more vehicles, the one or more vehicles in proximity to the vehicle, wherein the one or more communication signals comprise one or more of GPS location signals of the one or more vehicles, a DSRC signal, a cellular peer-to-peer signal, a Bluetooth signal, or a Wi-Fi signal.

12. The method of claim 10, wherein the one or more alarm actions comprise one or more of closing and locking one or more open doors of the one or more vehicles, closing and locking one or more open compartments of the one or more vehicles, activating one or more lights of the one or more vehicles, activating one or more sound devices of the one or more vehicles, activating one or more image capture devices for recording video, or outputting an alert message on a display of the one or more vehicles.

13. The method of claim 10, further comprising:
causing, based on user input, the alarm system to arm; and
causing, based on authorized access to the vehicle, the vehicle to discontinue the one or more alarm actions.

14. The method of claim 10, further comprising causing, based on the unauthorized access to the vehicle, the vehicle to initiate one or more second alarm actions.

15. The method of claim 14, wherein the one or more second alarm actions comprise one or more of closing and locking one or more open doors of the one or more vehicles, closing and locking one or more open compartments of the one or more vehicles, activating one or more lights of the one or more vehicles, activating one or more sound devices of the one or more vehicles, activating one or more image capture devices for recording video, or outputting an alert message on a display of the one or more vehicles, wherein the one or more lights of the one or more vehicles are activated in a pattern that differs from a pattern of one or more lights of the vehicle.

16. A method comprising:
causing, by a computing device, based on arming an alarm system of a vehicle, each door of one or more doors of the vehicle and each compartment of one or more compartments of the vehicle to lock;
based on detecting unauthorized access to the one or more doors or the one or more compartments while the alarm system is armed, determining unauthorized access to the vehicle; and
causing, based on the unauthorized access to the vehicle, the vehicle and one or more vehicles in proximity to the vehicle to initiate one or more alarm actions.

17. The method of claim 16, further comprising determining, based on the unauthorized access to the vehicle and based on one or more communication signals associated with the one or more vehicles, the one or more vehicles in proximity to the vehicle, wherein the one or more communication signals comprise one or more of GPS location signals of the one or more vehicles, a DSRC signal, a cellular peer-to-peer signal, a Bluetooth signal, or a Wi-Fi signal.

18. The method of claim 16, wherein the one or more alarm actions comprise one or more of closing and locking one or more open doors, closing and locking one or more open compartments, activating one or more lights, activating one or more sound devices, outputting an alert message on a display, activating one or more image capture devices for recording video, or sending one or more notifications to one or more users, sending a message to law enforcement.

19. The method of claim 16, wherein causing, based on the unauthorized access to the vehicle, the vehicle and the one or more vehicles in proximity to the vehicle to initiate the one or more alarm actions comprises:
causing, based on the unauthorized access to the vehicle, one or more lights of the one or more vehicles to activate according to a pattern that differs from a pattern of one or more lights of the vehicle.

20. The method of claim 16, further comprising:
causing, based on user input, the alarm system to arm; and
causing, based on authorized access to the vehicle, the vehicle and the one or more vehicles to discontinue the one or more alarm actions.
